(19) United States
(12) Patent Application Publication
(10) Pub. No.: US 2011/0242584 A1
(43) Pub. Date: Oct. 6, 2011

(54) PRINTING APPARATUS, CONTROL METHOD THEREOF AND STORAGE MEDIUM

(75) Inventor: Hiroya Igarashi, Yokohama-shi (JP)

(73) Assignee: CANON KABUSHIKI KAISHA, Tokyo (JP)

(21) Appl. No.: 12/996,679

(22) PCT Filed: Oct. 20, 2010
(86) PCT No.: PCT/JP2010/069015

§ 371 Date: Dec. 7, 2010

(30) Foreign Application Priority Data
Nov. 30, 2009 (JP) 2009-272802

(51) Int. Cl. G06K 15/00

(52) U.S. Cl. 358/1.15

(57) ABSTRACT

The attributes of the front and back surfaces of a sheet stored in each of sheet storing units which store sheets used in printing are set. Printing is done by selecting a sheet storing unit used in a print job from the sheet storing units in accordance with the attributes of the front and back surfaces of a sheet that are set by a print job from an information processing terminal and the attributes of the front and back surfaces of a sheet set in each sheet storing unit.

### TECHNICAL FIELD

The present invention relates to a printing apparatus for printing by selecting a sheet in accordance with print data and the attributes of the front and back surfaces of a sheet set in a sheet feed tray, and a control method of the printing apparatus.

### BACKGROUND ART

Some sheets used in printing differ in attribute (for example, paper quality or surface property) between the front and back surfaces, like one-side coated paper. When printing on such a sheet, a user needs to prepare print data in consideration of the correspondence between the front or back surface of the sheet and a page to be printed on the surface.

When setting sheets in the sheet storing unit of a printing apparatus such as a multifunction peripheral or printer, the user needs to correctly set the front and back surfaces of the sheets while taking account of the page number of print data for which coated paper is designated. Assume that print data of six pages is generated such that print data of the third and sixth pages is to be printed on coated papers, and the remaining pages are to be printed on plain papers. In this case, the user needs to set sheets so that the third page is printed on the coated surface of one-side coated paper, and the sixth page is also printed on that of one-side coated paper. Note that one page is printed on one surface of a sheet here. Conventionally, the user needs to carefully set sheets so that the third and sixth pages are printed on the coated surfaces of one-side coated sheets. If the user sets sheets with their front and back surfaces being reversed, an image is printed on a surface that the user does not want.

As a technique for printing on a sheet having different attributes between the front and back surfaces, there is proposed a technique disclosed in Japanese Patent Laid-Open No. 2001-127947. In the technique disclosed in Japanese Patent Laid-Open No. 2001-127947, when double-sided printing of two pages of color and monochrome images, the coated surface of a sheet set in a sheet feed tray is determined by reading a sheet identification mark. When it is determined that the color print data will not be printed on the coated surface of the sheet, the order of the color and monochrome images is changed to print the print data of the color image on the coated surface. In a technique disclosed in Japanese Patent Laid-Open No. 2007-084223, the paper quality of the front surface of a sheet is read. If the paper quality is different from a setting by a printer driver, the sheet is reversed to read again the paper quality of the current front surface of the sheet. If the paper quality is the same as the setting by the printer driver, printing on the sheet is done.

In the former method, however, comparison of image data with a sheet and exchange of image data take time, which leads to poor printing performance. In the latter method of reading the paper quality of the front surface of a sheet, the paper type is determined after feeding the sheet. If the sheet is set with its front and back surfaces being reversed, the user needs to reverse the sheet again in order to print. This decreases the printing speed. Especially in a large-scale image forming apparatus or the like, the time taken to reverse a sheet and convey it to a printing position is long, decreasing the productivity.

When print data which designates one-side coated paper or plain paper for each page is created using a PC or the like, and double-sided printing is designated, if print data to be printed on two surfaces designate both coated paper and plain paper, the printing apparatus prints on only one surface of each of plain paper and one-side coated paper. Assume that the PC transmits, to the printing apparatus, print data in which the paper designation of the first page is uncoated paper (plain paper), and that of the second page is coated paper. In this case, the printing apparatus feeds, as the first sheet, a sheet (plain paper) whose two surfaces are uncoated surfaces, and prints the first page on it. Since the image of the second page designates coated paper, the printing apparatus feeds one-side coated paper as the second sheet, and prints the second page on it, instead of printing on the back surface of the first plain paper on which the first page has been printed. Hence, even if the user wants to print the first page on the uncoated surface of one-side coated paper and the second page on the back surface (coated surface) of the same one-side coated paper, the user cannot obtain the printing result that the user wants.

When designating double-sided printing, the PC may match the attributes of images to be printed with the attribute of the front and back surfaces of a sheet. For example, when the paper designation of the second page of print data which designates plain paper for both the first and second pages is changed to coated paper designation, the paper designation of the first page may also be synchronously changed to coated paper designation. In this case, if one-side coated paper is set, the printing apparatus desirably prints the first page on the uncoated surface and the second page on the coated surface. However, the printing apparatus cannot determine which of the coated and uncoated surfaces of one-side coated paper should be printed with a page of print data received from the PC.

As described above, even if the user sets different paper attributes between print data of a page corresponding to the front surface of a sheet and print data of a page corresponding to the back surface, and designates double-sided printing, the double-sided printing cannot be appropriately done in accordance with the set paper attributes.

### SUMMARY OF INVENTION

An aspect of the present invention is to eliminate the above-mentioned problems with the conventional technology.

It is a feature of the present invention to print by, when print data designating paper attributes different between print data of a page corresponding to the front surface of a sheet and print data of a page corresponding to the back surface is supplied, selecting a sheet storing unit which stores a sheet corresponding to the respective attributes.

According to an aspect of present invention, there is provided a printing apparatus comprising: a plurality of sheet storing means each for storing a sheet used in printing; attribute setting means for setting attributes of front and back surfaces of a sheet stored in each of the plurality of sheet storing means; obtaining means for obtaining attributes of front and back surfaces of a sheet that are designated by a print job; and selection means for selecting sheet storing means used in the print job from the plurality of sheet storing means in accordance with the attributes of the front and back surfaces of the sheet that are set by the attribute setting means and an obtaining result obtained by the obtaining means.

According to another aspect of present invention, there is provided a control method of controlling a printing apparatus, the method comprising: an attribute setting step of setting attributes of front and back surfaces of a sheet stored in each of a plurality of sheet storing units; an obtaining step of obtaining attributes of front and back surfaces of a sheet that are designated by a print job; and a selection step of selecting a sheet storing unit used in the print job from the plurality of sheet storing units in accordance with the attributes of the front and back surfaces of the sheet that are set in the attribute setting step and an obtaining result obtained in the obtaining step.

Further features and aspects of the present invention will become apparent from the following description of exemplary embodiments, with reference to the attached drawings.

### BRIEF DESCRIPTION OF DRAWINGS

The accompanying drawings, which are incorporated in and constitute a part of the specification, illustrate embodiments of the invention and, together with the description, serve to explain the principles of the invention.

FIG. 1 depicts a view showing the arrangement of a system according to an embodiment of the present invention;

FIG. 2 is a block diagram for describing the arrangement of an image forming apparatus (MFP) according to the embodiment;

FIG. 3 depicts a view illustrating an example of a paper registration screen;

FIG. 4A depicts a view illustrating an example of a screen for registering the characteristic of the front surface of a sheet set in a selected paper feed tray;

FIG. 4B depicts a view illustrating an example of a screen for registering the characteristic of the back surface of a sheet set in a selected paper feed tray;

FIG. 5 depicts a view illustrating an example of a printer driver property screen displayed by a PC;

FIG. 6 depicts a view illustrating an example of a paper type setting screen according to the embodiment;

FIG. 7 is a flowchart describing processing of outputting a print instruction from the PC to the MFP;

FIG. 8 is a flowchart describing processing of analyzing print data received by the MFP from the PC and printing it according to a first embodiment;

FIG. 9 is a flowchart describing processing of registering a sheet in the paper feed tray of an MFP according to a second embodiment;

FIG. 10 depicts a view illustrating an example of a screen for registering a sheet opposite in front and back surface characteristics to a sheet set in step S22;

FIG. 11 is a flowchart describing processing by a PC according to a third embodiment;

FIG. 12 is a flowchart describing processing of analyzing print data received by a print server from the PC, and instructing the MFP to print it according to the third embodiment; and

FIG. 13 depicts a sectional view illustrating an example of the structure of the image forming apparatus (MFP) according to the embodiment.

### DESCRIPTION OF EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

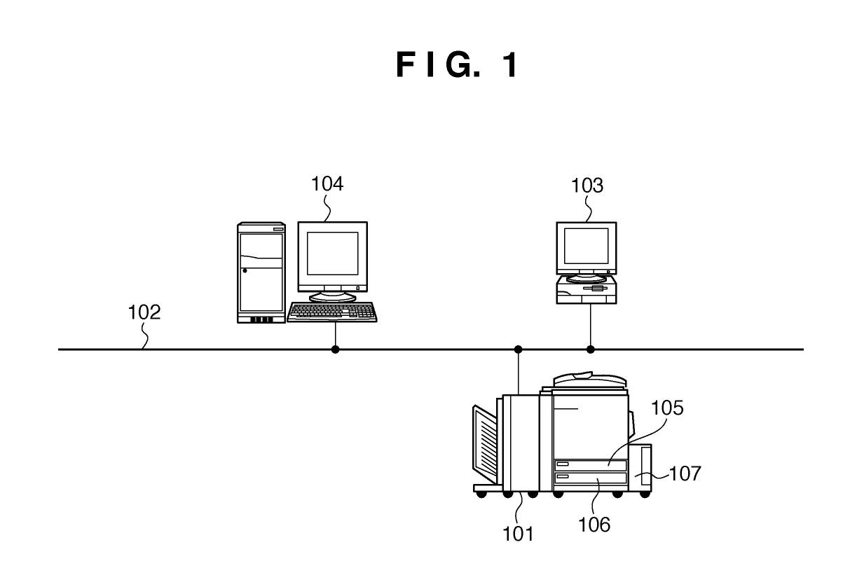

FIG. 1 depicts a view illustrating an example of the arrangement of a printing system according to an embodiment of the present invention.

The printing system includes an image forming apparatus (to be also referred to as a multifunction peripheral: MFP) 101, print server 104, and computer terminal (PC) (information processing terminal) 103 which are connected to a network 102. The MFP 101 has a plurality of paper feed trays including paper feed trays 105 and 106 and a paper feed deck 107. In FIG. 1, these three apparatuses are connected to the network 102, but the present invention is not limited to this.

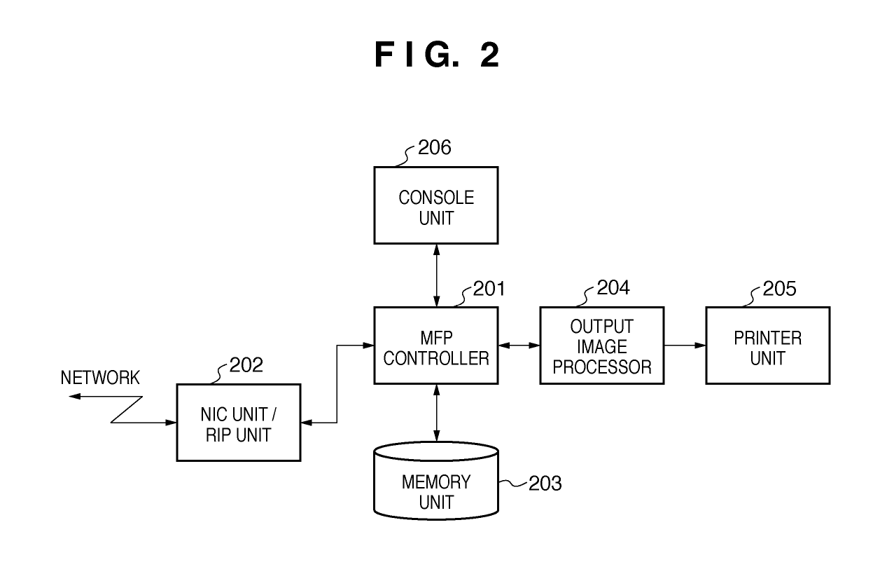

FIG. 2 is a block diagram describing the arrangement of the image forming apparatus (MFP) 101 as an example of a printing apparatus according to the embodiment.

Print data is input from the print server 104 or PC 103 to the image forming apparatus 101 via the network 102. A NIC (Network Interface Card) unit/RIP (Rater Image Processor) unit 202 receives the print data input via the network 102, decodes the received print data and rasterizes it. Such print data is mainly PDL data. The NIC unit/RIP unit 202 sends the rasterized print data to an MFP controller 201. The MFP controller 201 has a traffic control function of controlling input data and data to be output. The MFP controller 201 temporarily stores the received image data in a memory unit 203. If necessary, the multilevel image data stored in the memory unit 203 is read out and sent to an output image processor 204. The output image processor 204 performs image processing to the sent multilevel image data for printing, and sends the processed image data to a printer unit 205. The printer unit 205 feeds a sheet from the sheet feed tray, and sequentially prints, on the sheet, the print data sent from the output image processor 204. A console unit 206 includes the touch panel display (to be referred to as a display panel) of the MFP 101, and various operation keys. The console unit 206 is used for the start/stop operations of functions such as copying and FAX, various settings of the MFP, and the like. The contents of an operation on the console unit 206 are sent to the MFP controller 201. Note that the NIC unit and RIP unit are implemented by a single arrangement, but may be implemented by different arrangements.

Next, processing of registering, in the MFP 101, sheets set in a plurality of paper feed trays of the MFP 101 will be explained. The user performs the registration processing using the display panel of the console unit 206 of the MFP 101.

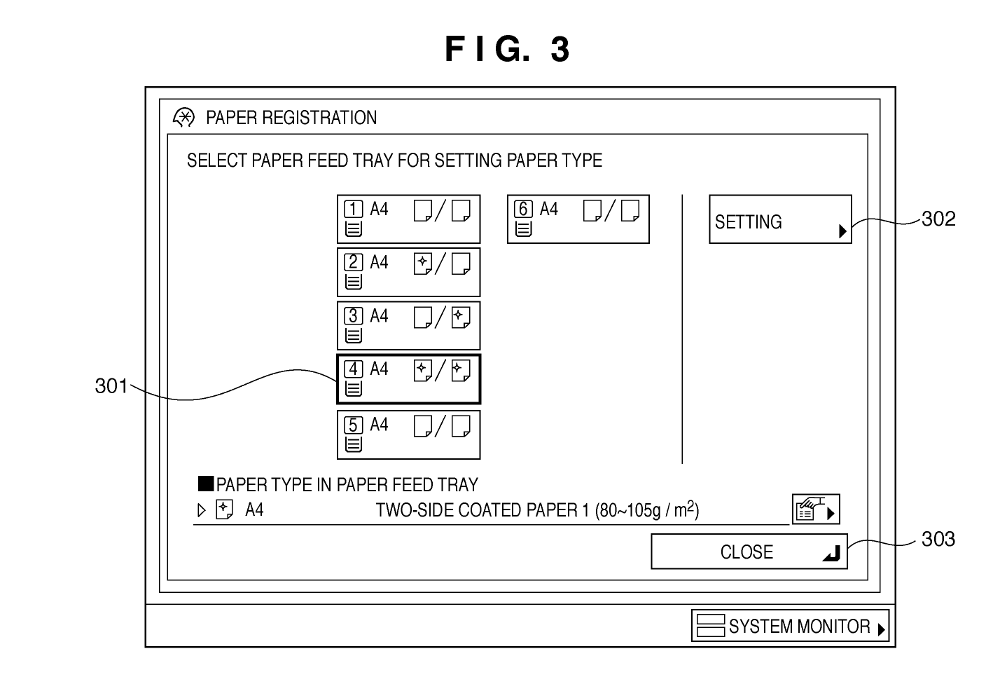

FIG. 3 depicts a view illustrating an example of a paper registration screen displayed on the display panel of the console unit 206 of the MFP 101.

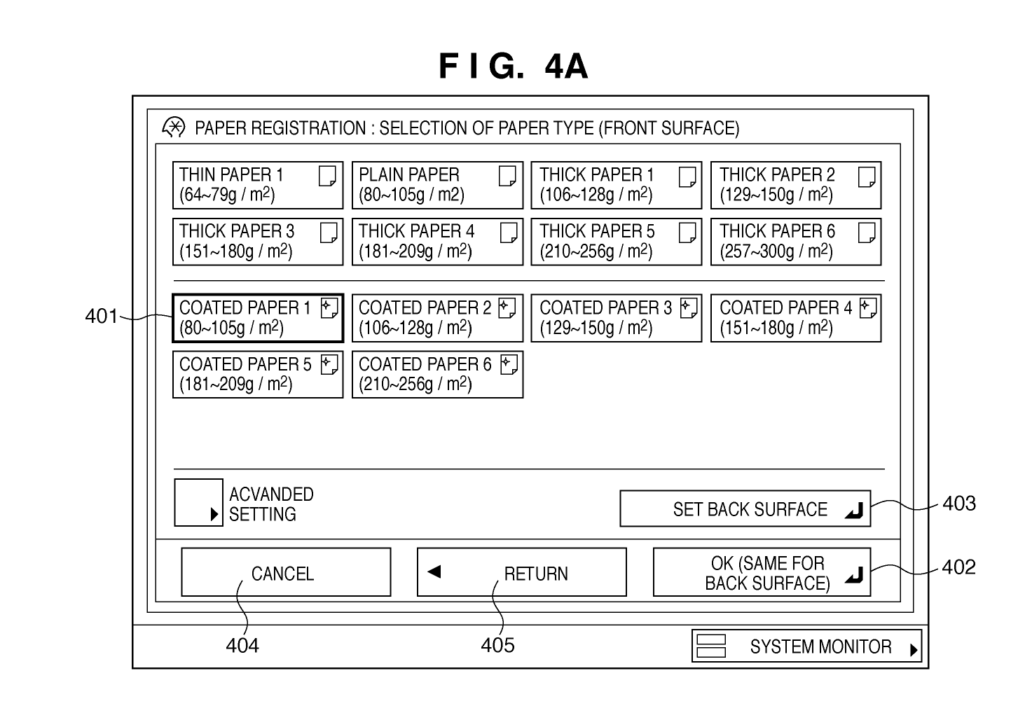

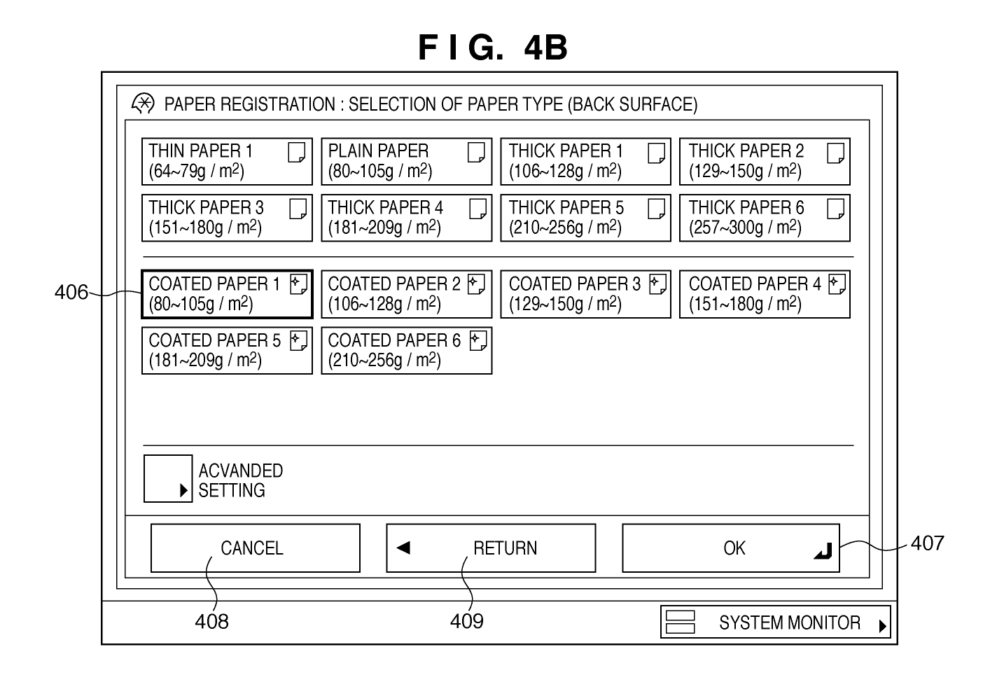

This screen displays a plurality of paper feed trays of the MFP 101, and the sizes of sheets set in the respective paper feed trays. In FIG. 3, the user selects the fourth paper feed tray, and the display color of a button 301 corresponding to the selected paper feed tray is changed. In the selected paper feed tray, A4 two-side “coated paper 1” is set. If it is detected that the user has pressed a setting button 302, the MFP controller 201 displays, on the display panel, a paper type selection screen for the front surface shown in FIG. 4A. If it is detected that the user has pressed a close button 303, the paper registration setting is aborted.

FIG. 4A depicts a view illustrating an example of a screen for registering the attribute (type, characteristic, or surface property) of the front surface of a sheet set in a paper feed tray selected in FIG. 3. FIG. 4B depicts a view exemplifying a screen for registering the attribute (type, characteristic, or surface property) of the back surface of a sheet set in a paper feed tray selected in FIG. 3.

In FIG. 4A, a paper type list is displayed. The user selects, from the list, the paper type (“coated paper 1”) of the front surface of a sheet to be set or a sheet set in a designated paper feed tray (fourth paper feed tray in this example). In response to this, the MFP controller 201 changes the display color of a button 401 of the selected paper type. If the user presses an OK (same for the back surface) button 402 in this state, the setting of the back surface of the sheet becomes the same as that of the front surface. That is to say, if the user presses the OK (same for the back surface) button 402 in FIG. 4A, both the front and back surfaces are set as “coated paper 1” whose two surfaces are coated paper. If the user presses a back surface setting button 403, the MFP controller 201 displays, on the display panel, a paper type selection screen for the back surface shown in FIG. 4B. If the user presses a cancel button 404 in FIG. 4A, the paper type setting is canceled. If the user presses a return button 405, the screen in FIG. 4A returns to the paper feed tray selection screen in FIG. 3. Note that the front surface of a sheet is a surface which is printed first after the sheet is fed from the paper feed tray. For example, when setting a sheet in the paper feed tray 105 or 106, it needs to be set with its surface desired to be first printed facing down. This is because a sheet fed from the paper feed tray 105 or 106 is printed first from a surface set to face down in the paper feed tray. To the contrary, when setting a sheet on the paper feed deck 107, it needs to be set with its surface desired to be first printed facing up. This is because a sheet fed from the paper feed deck 107 is printed first from a surface set to face up on the paper feed deck.

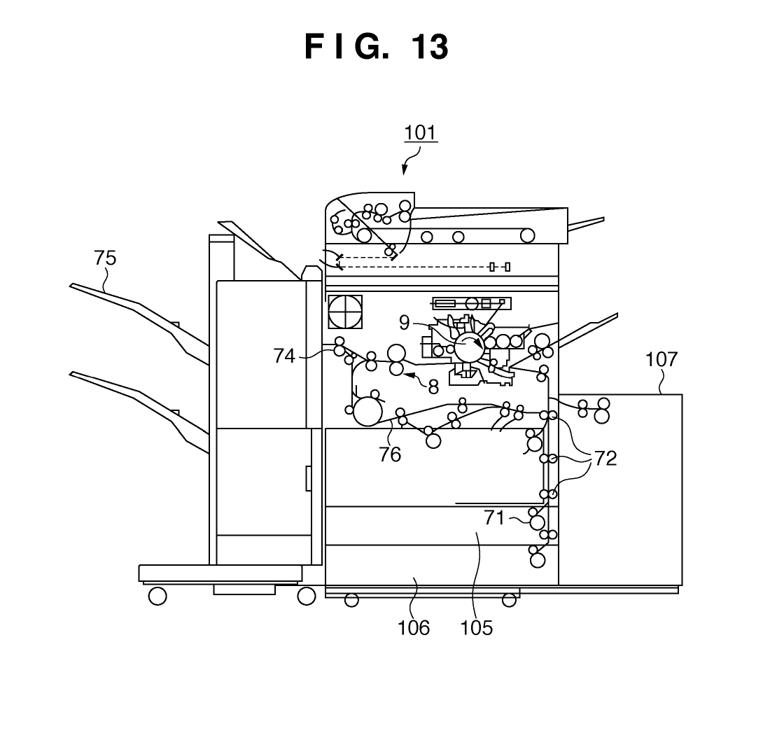

The conveyance path of the MFP 101 and a direction in which a sheet is printed on the conveyance path in the embodiment will be exemplified in detail with reference to FIG. 13.

A sheet set in the paper feed tray 105 or 106 is fed by a paper feed roller 71, and conveyed to the position of a transfer member 9 by conveyance rollers 72. During this process, a sheet surface which faced down in FIG. 13 when the sheet was set in the paper feed tray faces up in FIG. 13 when the sheet reaches the position of the transfer member 9. Then, the transfer member 9 transfers an image onto the upper surface (front surface) of the sheet. A fixing unit 8 fixes the image onto the sheet, and a conveyance roller 74 conveys the sheet to a double-sided print path 76 if double-sided printing is designated. In single-sided printing, the sheet onto which the fixing unit 8 has fixed the image is discharged to a paper discharge tray 75. This structure is merely an example, and it suffices to properly change the facing direction of a sheet to be set in the paper feed tray depending on the structure of the printing apparatus, particularly the conveyance path and the direction in which a sheet is printed on the conveyance path. In the embodiment, the MFP 101 prints according to an electrophotographic method. However, the present invention is not limited to this and is applicable to even an inkjet method or other printing methods.

In FIG. 4B, a paper type list is displayed, similar to the front surface in FIG. 4A. The user selects, from the list, the paper type (“coated paper 1” similarly to the front surface) of the back surface of a sheet to be set or a sheet set in a designated paper feed tray (fourth paper feed tray in this example). Also in this case, the MFP controller 201 changes the display color of a button 406 of the selected paper type. If the user presses an OK button 407 in this state, the paper type setting of the back surface is completed. If the user presses a cancel button 408, the paper type setting is canceled. If the user presses a return button 409, the screen in FIG. 4B returns to the paper type selection screen for the front surface in FIG. 4A. In this way, the characteristics of the front and back surfaces of a sheet set in a user desired paper feed tray can be set using the screens in FIGS. 4A and 4B. Note that the back surface of a sheet is a surface opposite to the front surface of the sheet. In single-sided printing, the back surface of a sheet is not printed. In double-sided printing, after the front surface of a sheet is printed, the sheet is reversed through the double-sided print path 76 in FIG. 13, and the back surface of the sheet is printed by the transfer member 9. The fixing unit 8 fixes the image transferred onto the sheet, and the sheet is conveyed by the conveyance roller 74 and discharged to the paper discharge tray 75.

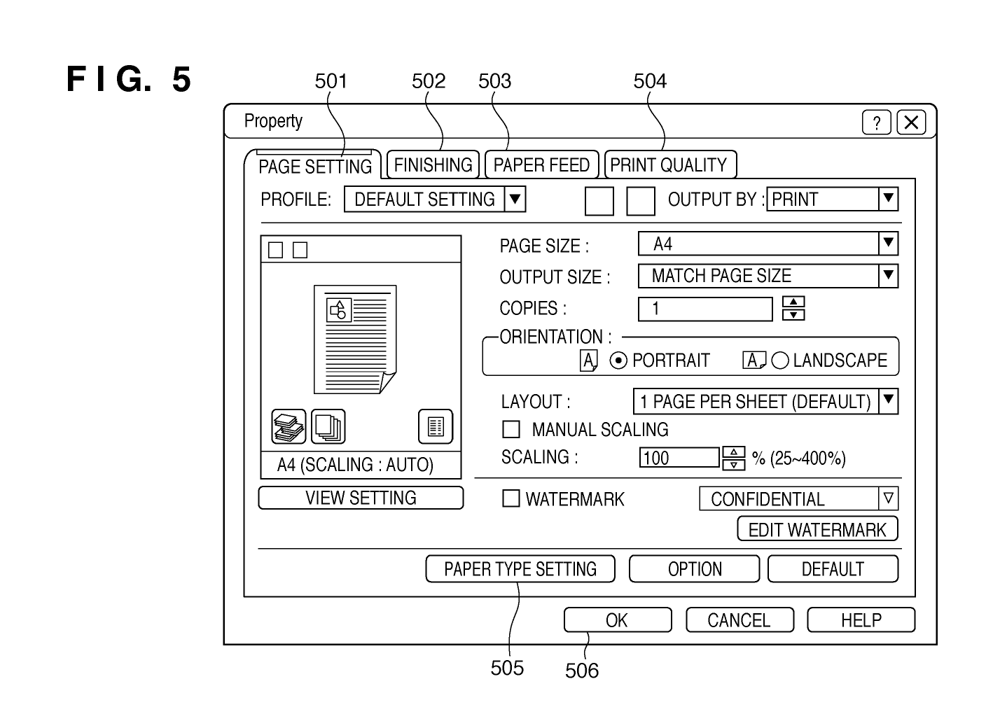

FIG. 5 depicts a view illustrating an example of a printer driver setting screen displayed by the PC 103.

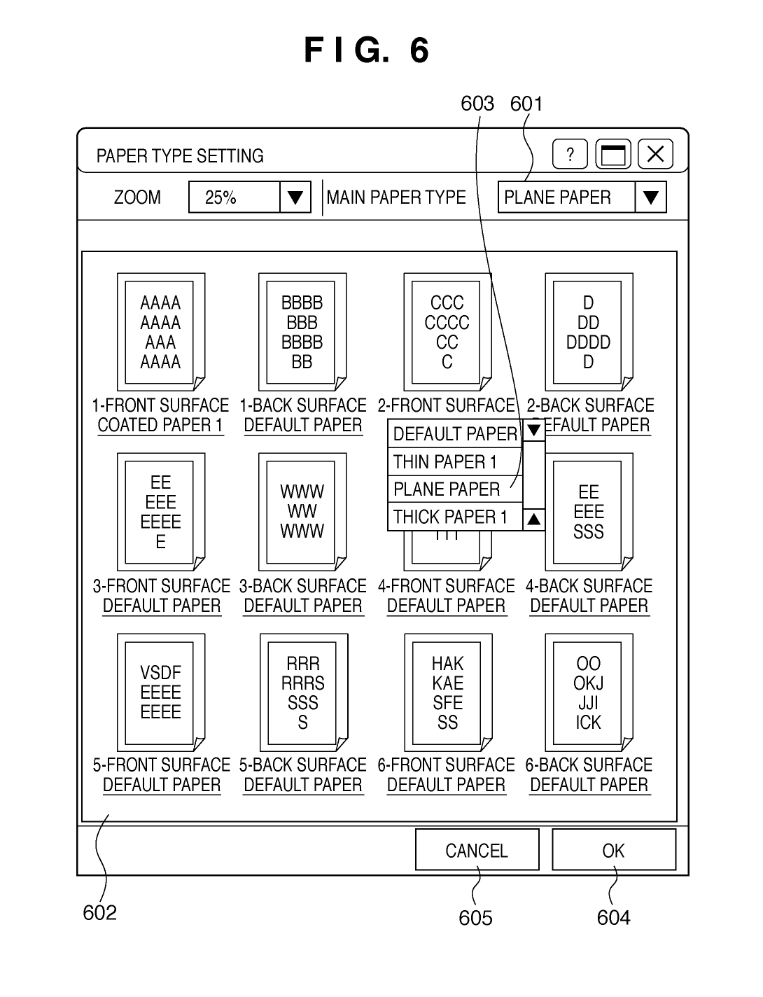

When an application which has created print data on the PC 103 issues a print instruction, the printer driver property screen shown in FIG. 5 appears. A page setting tab 501 allows the user to set the page size (A4 in this example), copies (one copy in this example), the orientation (portrait in this example), and the like. A finishing tab 502 allows the user to set finishing processes such as stapling, punching, and single/double-sided finishing process. A paper feed tab 503 allows the user to designate a paper feed tray which stores sheets to be printed by the MFP 101. A print quality tab 504 allows the user to set the color mode and the like. To change the paper type for each page, the user uses a paper type setting button 505 on the page setting tab 501. If the user presses the paper type setting button 505, the printer driver displays a paper type setting screen shown in FIG. 6.

FIG. 6 depicts a view illustrating an example of a paper type setting screen according to the embodiment. This screen allows the user to set the type of sheet used to print each page.

In a main paper type setting dialog 601, the user selects a paper type used mainly in printing. In FIG. 6, “plain paper” is selected. A paper type setting area 602 displays the thumbnails of the front and back surfaces for each paper type. By designating a thumbnail, the user can set a page number, print surface, and paper type for use. In this example, when the user designates an underlined character string below each thumbnail, the printer driver displays a paper type list 603 of paper types which can be set for the front or back surface of the sheet. The user selects a paper type the user wants from the paper type list 603. In the example of FIG. 6, the user can designate one of “thin paper 1”, “plain paper”, and “thick paper 1” as “default paper of 4-front surface” from the paper type list 603. In this fashion, the user can designate a paper type used in printing, and the attributes of the front and back surfaces. After the end of the setting, the user presses an OK button 604, completing the setting. The screen in FIG. 6 returns to the printer driver property screen in FIG. 5. If the user presses a cancel button 605, settings on the screen are canceled, and the screen in FIG. 6 returns to the printer driver screen in FIG. 5. If the user presses an OK button 506 in FIG. 5, the printer driver instructs the MFP 101 and print server 104 to print. When a paper type designated by print data of a page corresponding to the front surface and print data of a page corresponding to the back surface, which are printed on one sheet, does not match a paper type used in printing, the MFP controller 201 warns the user about it. If the user sets different paper types between print data of the front surface and print data of the back surface, this setting may not be reflected. The paper type differs between print data of the front surface and print data of the back surface, that is a case where, for example, print data of the front surface designates “thick paper” and print data of the back surface designates “thin paper”. If the user wants to print using “one-side coated paper”, the user sets a paper type “coated paper” for print data of a page desired to be printed on a coated surface. In this case, “coated paper” need not always be designated for print data of a page corresponding to the back surface of the page having the “coated paper” setting, and, for example, “plain paper” may be set.

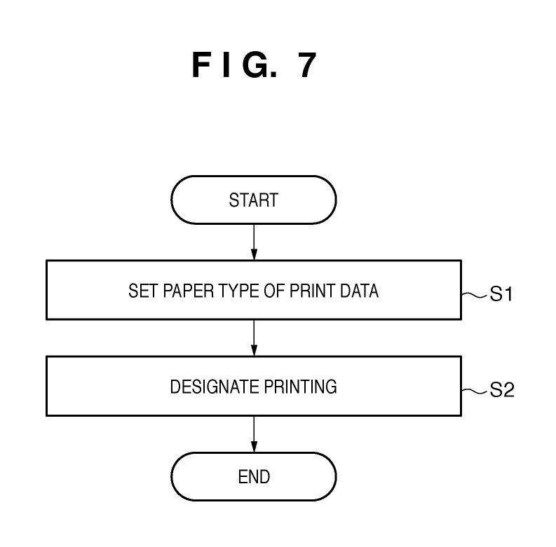

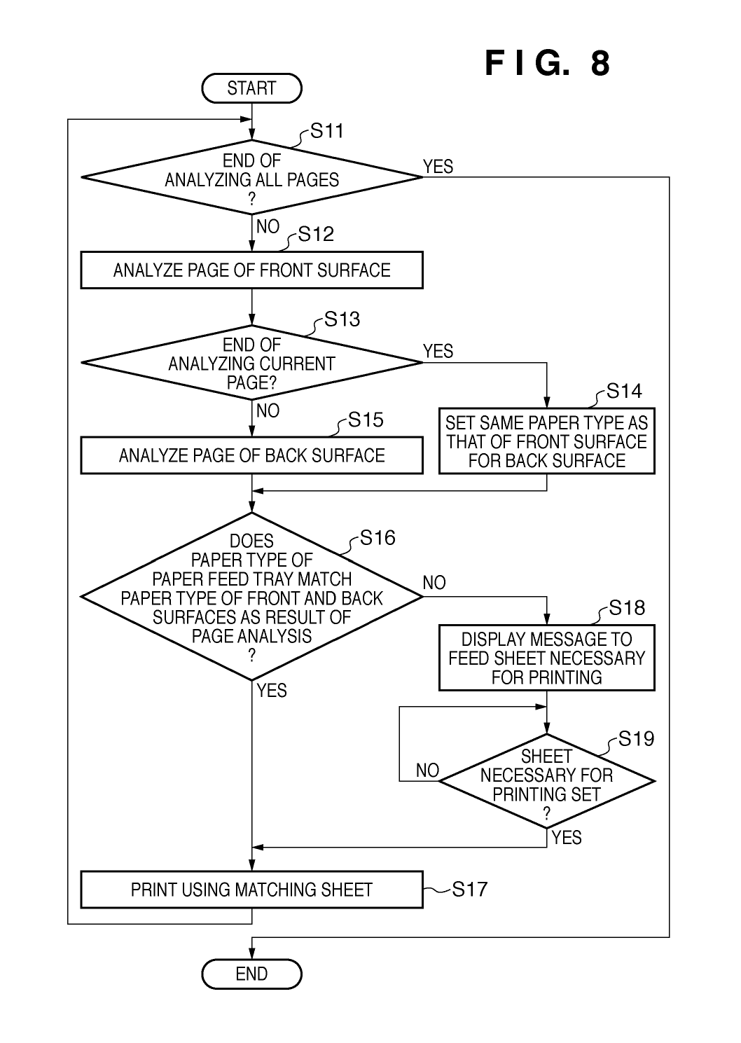

Control procedures in the first embodiment will be explained with reference to FIGS. 7 and 8.

FIG. 7 is a flowchart describing processing of outputting a print instruction from the computer terminal (PC) 103 to the MFP 101. Note that the CPU of the PC 103 performs the processing shown in the flowchart of FIG. 7 by executing a program stored in the memory. Assume that the characteristics of the front and back surfaces of sheets loaded (stored) in each paper feed tray of the MFP 101 have been set in the MFP 101 as described with reference to FIGS. 3, 4A, and 4B before executing this processing.

In step S1, a paper type for each page of print data is set based on the printer driver settings described with reference to FIGS. 5 and 6. The process advances to step S2, and the PC 103 issues a print job to the MFP 101 to instruct it to print.

FIG. 8 is a flowchart describing processing of analyzing print data received by the MFP 101 from the PC 103 and printing it according to the first embodiment. The CPU (not shown) of the MFP controller 201 implements this processing by executing a program stored in the memory unit 203.

This print processing assumes that double-sided printing is designated. First, in step S11, the MFP controller 201 determines whether the analysis of all pages of print data received from the PC 103 is completed. If the MFP controller 201 determines in step S11 that the analysis of all pages is completed, the process ends. If the MFP controller 201 determines in step S11 that the analysis of all pages is not completed, the process advances to step S12 to keep analyzing the print data. In step S12, the MFP controller 201 analyzes print data of the front surface of the first double-sided printing of the received print data. By this analysis, the MFP controller 201 obtains type information of a sheet on which the print data of the front surface is to be printed. Then, the process advances to step S13, and the MFP controller 201 determines whether the page analysis of print data of the back surface of the first double-sided printing of the received print data is completed or the analysis of the back surface is unnecessary. If the MFP controller 201 determines in step S13 that the analysis is completed or unnecessary, the process advances to step S14, and the MFP controller 201 gives the same settings to the front and back surfaces. The analysis becomes unnecessary, for example, when the back surface is set to the same type as that of the front surface or when single-sided printing is designated. If the MFP controller 201 determines in step S13 that the analysis is necessary, the process advances to step S15. In step S15, the MFP controller 201 analyzes page information of print data of the back surface of the first double-sided printing of the received print data. By this analysis, the MFP controller 201 obtains paper type information of the print data of the back surface and the process advances to step S16.

In step S16, the MFP controller 201 compares the paper type of the front and back surfaces of the print data that has been obtained by the analysis in steps S12 and S15, with information of a sheet set in a paper feed tray selected in the MFP 101. If the paper type of the front and back surfaces matches type information of the sheet set in the selected paper feed tray, the process advances to step S17, and the MFP controller 201 prints the print data of the page using the sheet set in the selected paper feed tray. After that, the process returns to step S11 to analyze the next double-sided printing page.

If the MFP controller 201 determines in step S16 that the paper types of the front and back surfaces does not match type information of the sheet, the process advances to step S18. In step S18, a sheet necessary for printing does not exist in the paper feed tray of the MFP 101, so the MFP controller 201 displays a message on the display panel of the console unit 206 to prompt the user to feed a sheet necessary for printing. The process then advances to step S19 and waits until the user loads a sheet in one of the paper feed trays of the MFP 101, selects the paper feed tray as described with reference to FIGS. 3, 4A, and 4B, and sets the type of the loaded sheet. After the setting in the paper feed tray, the MFP controller 201 determines whether the type of sheet set in the paper feed tray matches the paper types analyzed in steps S12 and S15. If the MFP controller 201 determines that a sheet necessary for printing is set, the process advances to step S17, and the MFP controller 201 prints using the sheet. If a sheet different from one necessary for printing is set or no sheet has been set, the MFP controller 201 executes the process in step S19 to wait for setting of a sheet necessary for printing.

According to the first embodiment, if a sheet suited to printing is not loaded in a paper feed tray, then a message can be displayed to prompt the user to load a sheet necessary for printing.

This control allows the user to set different attributes (for example, types) between print data of a page corresponding to the front surface of a sheet and print data of a page corresponding to the back surface, select a paper feed tray which stores a sheet corresponding to the respective attributes, and print. Based on type information of a sheet set in the paper feed tray, the MFP 101 can determine whether a correct sheet can be fed. Thus, printing can be done while preventing a decrease in productivity as much as possible.

### Second Embodiment

The second embodiment of the present invention will be described. In the second embodiment, a paper feed tray loaded with a sheet opposite in front and back surface characteristics to a sheet in a selected paper feed tray is prepared. For example, the first paper feed tray loaded with sheets (each sheet is one-side coated paper (back surface is plain paper)) each of whose front surface only is coated paper are set. At the same time, the second paper feed tray loaded with sheets (each sheet is one-side coated paper (front surface is plain paper)) each of whose back surface only is coated paper, unlike the first paper feed tray, are set. When print data of the front surface is data for coated paper and print data of the back surface is data for plain paper in double-sided printing, the data is printed by supplying a sheet from the first paper feed tray. To the contrary, when print data of the back surface is data for coated paper and print data of the front surface is data for plain paper in double-sided printing, the data is printed by supplying a sheet from the second paper feed tray different from the first paper feed tray. Note that the arrangements of a printing system and MFP 101 in the second embodiment are the same as those in the first embodiment, and a description thereof will not be repeated.

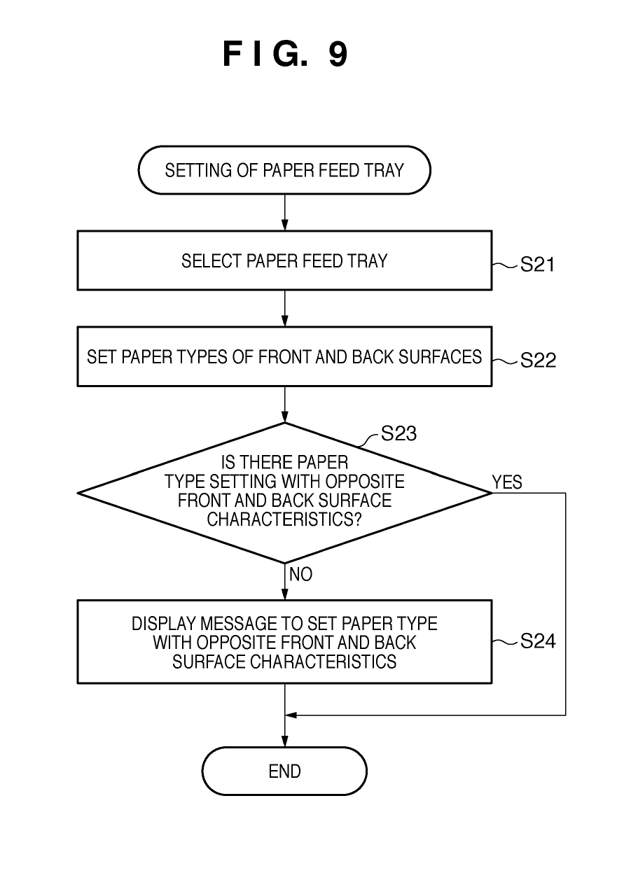

FIG. 9 is a flowchart describing processing of registering a sheet in the paper feed tray of the MFP 101 according to the second embodiment. The CPU (not shown) of an MFP controller 201 implements this processing by executing a program stored in a memory unit 203.

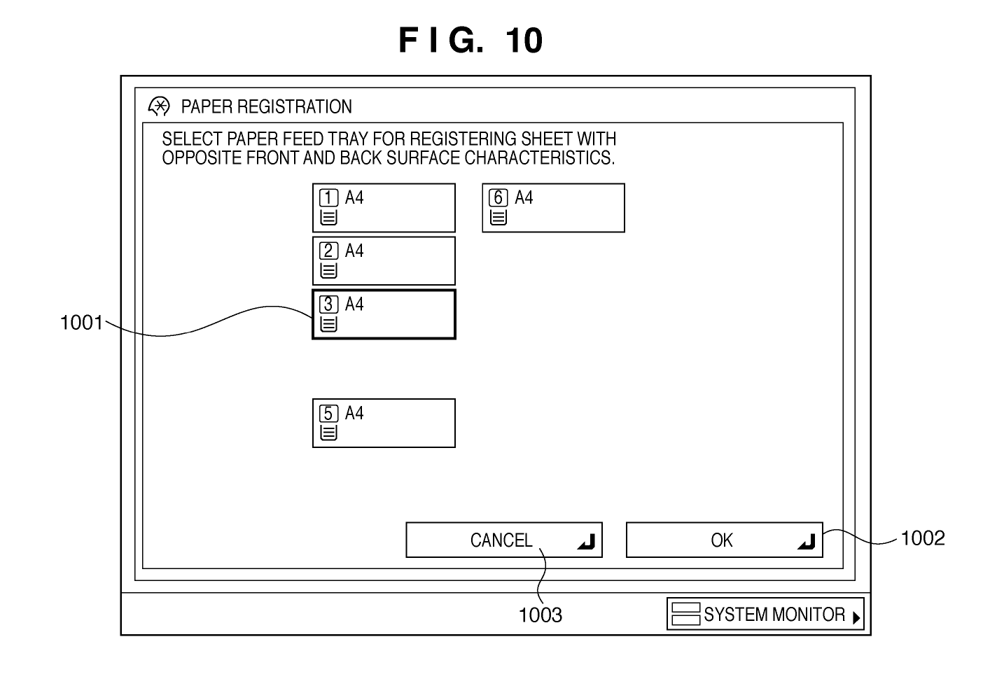

This processing starts when paper registration processing is activated. First, in step S21, the MFP controller 201 displays the registration screen as shown in FIG. 3 on the display panel of a console unit 206, and the user selects a paper feed tray used in printing. The process then advances to step S22, and the MFP controller 201 displays the screens shown in FIGS. 4A and 4B and the user sets the attributes of the front and back surfaces of a sheet set in the paper feed tray selected in step S21. The process advances to step S23, and the MFP controller 201 determines whether there is a paper feed tray which stores a sheet opposite in front and back surface characteristics to a sheet in the selected paper feed tray. If the MFP controller 201 determines in step S23 that there is a paper feed tray which store a sheet having opposite front and back surface characteristics, then the paper registration ends. If the MFP controller 201 determines in step S23 that there is no paper feed tray which stores a sheet opposite in front and back surface characteristics to a sheet in the selected paper feed tray, the process advances to step S24. In step S24, the MFP controller 201 displays, on the display panel of the console unit 206, a paper type registration screen for registering a paper feed tray having a sheet of opposite front and back surface characteristics shown in FIG. 10.

FIG. 10 depicts a view illustrating an example of a screen for registering a sheet opposite in front and back surface characteristics to a sheet set in step S22.

Since the fourth paper feed tray is selected in FIG. 3, a list of remaining paper feed trays is displayed in FIG. 10. In this example, the third paper feed tray is selected, and the display color of a display button 1001 corresponding to the third paper feed tray is changed. If the user presses an OK button 1002 in this state, a paper type opposite in front and back surface characteristics to a sheet loaded in the fourth paper feed tray (the selected paper feed tray) is set for the third paper feed tray. At this time, if the third paper feed tray has already stored a sheet opposite in front and back surface characteristics to a sheet loaded in the fourth paper feed tray, the user need not load a sheet. If not, the user needs to load the third paper feed tray with a sheet opposite in front and back surface characteristics to a sheet loaded in the fourth paper feed tray. If the user presses a cancel button 1003, the paper registration processing for opposite front and back surface characteristics is canceled.

In the second embodiment, the user is prompted to register a paper feed tray to be loaded with a sheet opposite in front and back surface characteristics to a sheet in the selected (fourth) paper feed tray. As circumstances demand, the MFP 101 can selectively use the fourth paper feed tray which stores a sheet whose front surface is coated paper and whose back surface is plain paper, and the third paper feed tray which stores a sheet whose front surface is plain paper and whose back surface is coated paper. Therefore, the MFP 101 can smoothly print. More specifically, assume that print data of double-sided printing including the first page (coated paper), the second page (plain paper), the third page (coated paper), the fourth page (plain paper), the fifth page (plain paper), and the sixth page (coated paper) is received. Upon receiving this print data, the MFP controller 201 feeds the first and second sheets from the fourth paper feed tray to print the first to fourth pages, and the third sheet from the third paper feed tray to print the fifth and sixth pages.

### Third Embodiment

The third embodiment of the present invention will be described. In the third embodiment, a print server 104 determines a sheet for use, unlike the first embodiment. Note that the arrangements of a printing system and MFP 101 in the third embodiment are the same as those in the first embodiment, and a description thereof will not be repeated.

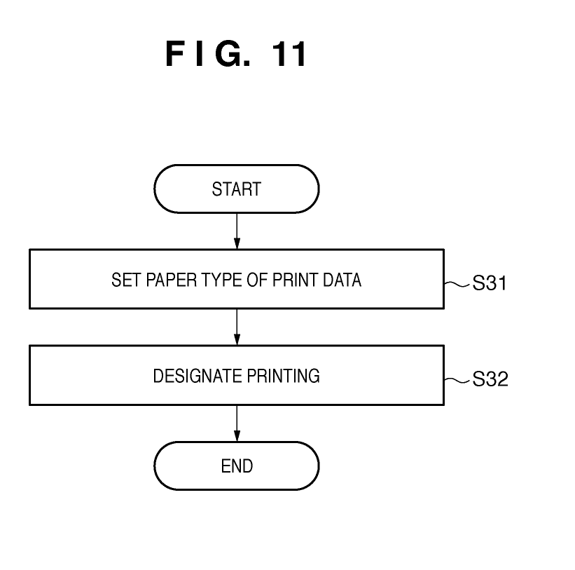

FIG. 11 is a flowchart describing processing by a user terminal (PC) 103 according to the third embodiment. The CPU of the user terminal (PC) 103 implements steps shown in the flowchart of FIG. 11 by executing a program stored in the memory. Before executing the processing, the MFP 101 transmits, to the print server 104, information of a paper feed tray set in the MFP 101. The print server 104 obtains the information of the paper feed tray set in the MFP 101.

In step S31, a paper type used in printing of print data is set based on the above-mentioned printer driver settings (FIGS. 5 and 6). The process advances to step S32 to issue a print instruction to the print server 104.

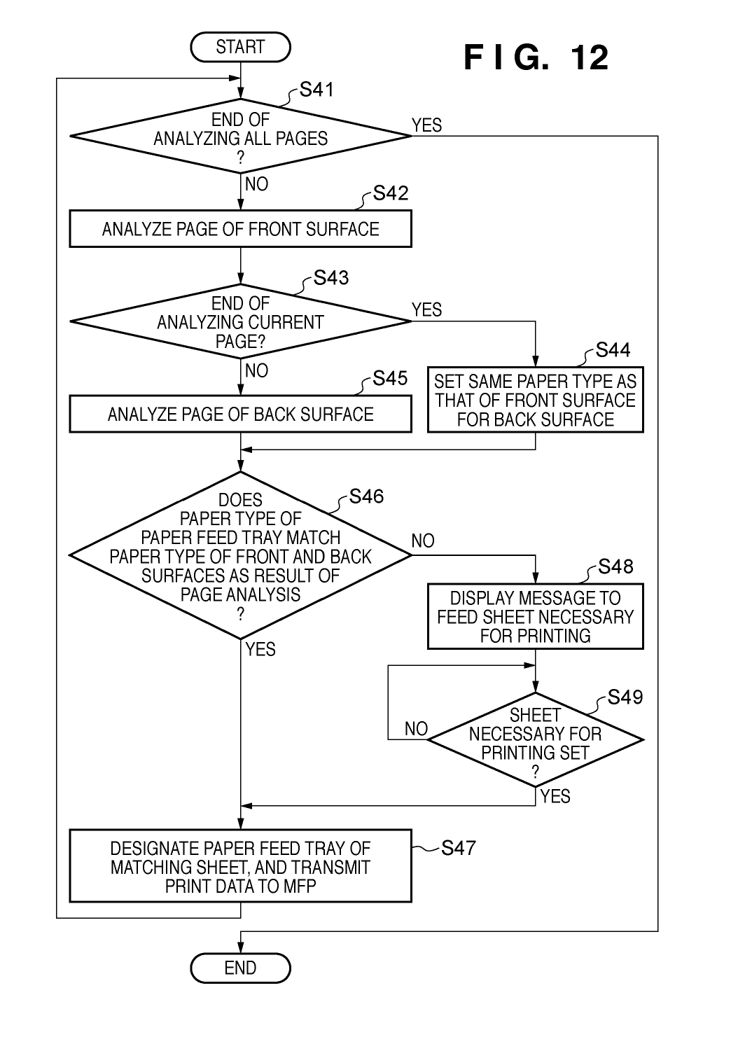

FIG. 12 is a flowchart describing processing of analyzing print data received by the print server 104 from the PC 103, and instructing the MFP 101 to print it according to the third embodiment. The CPU of the print server 104 performs steps shown in the flowchart of FIG. 12 by executing a program stored in the memory.

This print processing is premised on double-sided printing. First, in step S41, the CPU of the print server 104 determines whether the analysis of all pages of print data received from the PC 103 is completed. If the CPU of the print server 104 determines in step S41 that the analysis of all pages is completed, the process ends. If the CPU of the print server 104 determines in step S41 that the analysis of all pages is not completed, the process advances to step S42, and CPU of the print server 104 keeps analyzing the print data. In step S42, the CPU of the print server 104 analyzes print information of the front surface of the first double-sided page of the received print data. By this analysis, the server 104 obtains type information of a sheet on which the print data of the front surface is to be printed. Then, the process advances to step S43, and the CPU of the print server 104 determines whether the page analysis of the print data of the back surface of the first double-sided printing of the received print data is completed, or the analysis of the back surface is unnecessary. If the CPU of the print server 104 determines in step S43 that the analysis is completed or unnecessary, the process advances to step S44, and the CPU of the print server 104 gives the same settings to the front and back surfaces. If the CPU of the print server 104 determines in step S43 that the analysis is necessary, the process advances to step S45. In step S45, the CPU of the print server 104 analyzes page information of the back surface of the received print data. By this analysis, the print server 104 obtains paper type information of the back surface, and the process advances to step S46.

In step S46, the print server 104 compares the paper type of the front and back surfaces of print data that has been obtained by the analysis in steps S42 and S45, with information of a sheet set in a paper feed tray selected in the MFP 101. If the paper type of the front and back surfaces matches type information of the sheet set in the selected paper feed tray, the process advances to step S47, and the print server 104 designates the matching paper feed tray in the MFP 101, and transmits the print data to the MFP 101. Thereafter, the process returns to step S41. The MFP 101 prints in accordance with the print data using a sheet in the designated paper feed tray.

If the paper type of the front and back surfaces does not match type information of the sheet in step S46, the process advances to step S48. In step S48, a sheet necessary for printing does not exist in the selected paper feed tray of the MFP 101, so the print server 104 notifies the MFP 101 to set a sheet necessary for printing. In this case, a message is displayed on the display panel of a console unit 206 via a NIC unit 202 and MFP controller 201 to prompt the user to set the sheet. When the print server 104 has a display unit, this display unit may display a message to prompt the user to set the sheet. Then, the process advances to step S49 and waits until the user sets a sheet necessary for printing in the MFP 101 and selects a paper feed tray. The print server 104 determines, based on a signal from the MFP 101 that indicates the presence/absence of the sheet, whether the sheet necessary for printing has been set. If the necessary sheet is set, the process advances to step S47 to issue a print instruction to the MFP 101. If the print server 104 determines in step S49 that a sheet different from one necessary for printing is set, or if no sheet has been set, the print server 104 waits until the necessary sheet is set. In step S49, the print server 104 may analyze print data of the next and subsequent pages during standby for transmission of print data, in order to increase the printing speed.

According to the third embodiment, when a sheet suited to printing is not loaded in a paper feed tray, even the print server 104 can be used to display a message which prompts the user to load a sheet necessary for printing, similar to the first embodiment.

### Fourth Embodiment

In the fourth embodiment, when print data sets only any one of the types of the front and back surfaces of a sheet, a paper feed tray in which either the front or back surface of a sheet matches the print data setting is selected.

Also, when print data sets only any one of the types of the front and back surfaces of a sheet, a type opposite to the surface set by the print data is set to “plain paper”. For example, when print data sets the type of the front surface of a sheet as “coated paper” and does not set the type of the back surface of the sheet (for example, blank paper), the type of the back surface is set to “plain paper”. This is because, when print data designates the type of the front surface as “coated paper” and the back surface as blank paper, an MFP 101 can print by selecting not expensive two-side coated paper but a relatively low-cost one-side coated paper (back surface is plain paper).

### Other Embodiments

In the above-described embodiments, different types (for example, plain paper and coated paper) are set for the front and back surfaces of a sheet. However, the set value is not limited to this, and may be a value indicating the surface property of a sheet, or a value indicating the quality or grammage of a sheet. The present invention is also applicable to a case in which a value indicating a sheet characteristic (attribute) set by the user is separately set for the front and back surfaces of a sheet set in each paper feed tray, and the PC sets, in print data, a value corresponding to the value indicating the characteristic.

In the above-described embodiments, the printer driver designates a paper attribute as shown in FIG. 6, but application software in the PC may make the same setting.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2009-272802, filed Nov. 30, 2009, which is hereby incorporated by reference herein in its entirety.

1-6. (canceled)

7. A printing apparatus comprising:
a plurality of sheet storing units each storing a sheet;
an attribute setting unit that sets attributes of a first surface and a second surface of a sheet stored in each of the plurality of sheet storing units;
an obtaining unit that obtains an attribute of a first surface of a sheet which is designated for a job and an attribute of a second surface of the sheet which is designated for the job; and
a selection unit that selects, for the job from the plurality of sheet storing units, a sheet storing unit for which the attribute of the first surface which matches the attribute of the first surface obtained by the obtaining unit is set by the attribute setting unit and the attribute of the second surface which matches the attribute of the second surface obtained by the obtaining unit is set by the attribute setting unit.

8. The apparatus according to claim 7, further comprising a setting unit that sets attributes of first and second surfaces of a sheet that are opposite to attributes of first and second surfaces of a sheet set in a first sheet storing unit among the plurality of sheet storing units, for a sheet storing unit other than the first sheet storing unit from the plurality of sheet storing units.

9. The apparatus according to claim 7, further comprising a notification unit that, when a sheet storing unit for which the attribute of the first surface which matches the attribute of the first surface obtained by the obtaining unit is set by the attribute setting unit and the attribute of the second surface which matches the attribute of the second surface obtained by the obtaining unit is set by the attribute setting unit does not exist in the plurality of sheet storing units, notifies to set a sheet necessary for the job in the sheet storing unit.

10. The apparatus according to claim 9, further comprising a control unit that starts printing when a sheet having both the attributes of the first and second surfaces is set in one of the plurality of sheet storing units after a notification by the notification unit.

11. A control method of controlling a printing apparatus having a plurality of sheet storing units each storing a sheet, the method comprising:
an attribute setting step of setting attributes of a first surface and a second surface of a sheet stored in each of the plurality of sheet storing units;
an obtaining step of obtaining an attribute of a first surface of a sheet which is designated for the job and a second surface of the sheet which is designated for the job; and
a selection step of selecting, for the job from the plurality of sheet storing units, a sheet storing unit for which the attribute of the first surface which matches the attribute of the first surface obtained in the obtaining step is set in the attribute setting step and the attribute of the second surface which matches the attribute of the second surface obtained in the obtaining step is set in the attribute setting step.

12. A non-transitory computer-readable storage medium storing a program for causing a computer to execute a control method of a printing apparatus having a plurality of sheet storing units each for storing a sheet, the program causing the computer to execute
an attribute setting step of setting attributes of a first surface and a second surface of a sheet stored in each of the plurality of sheet storing units,
an obtaining step of obtaining an attribute of a first surface of a sheet which is designated for the job and a second surface of the sheet which is designated for the job, and
a selection step of selecting, for the job from the plurality of sheet storing units, a sheet storing unit for which the attribute of the first surface which matches the attribute of the first surface obtained in the obtaining step is set in the attribute setting step and the attribute of the second surface which matches the attribute of the second surface obtained in the obtaining step is set in the attribute setting step.
